(19) United States
(12) Patent Application Publication
(10) Pub. No.: US 2025/0264406 A1
(43) Pub. Date: Aug. 21, 2025

(54) INFRARED TRANSMISSION CELL WITH ATTACHED FLOW SENSOR FOR MICROFLUIDIC MODULATION SPECTROSCOPY

(71) Applicant: RedShift BioAnalytics, Inc., Boxborough, MA (US)

(72) Inventors: Jinhong Kim, Boxborough, MA (US); Eugene Ma, Newton, MA (US); Dennis Merrill, Boxborough, MA (US)

(21) Appl. No.: 19/060,150

(22) Filed: Feb. 21, 2025

Related U.S. Application Data
(60) Provisional application No. 63/556,173, filed on Feb. 21, 2024.

(51) Int. Cl. G01N 21/3577; G01N 21/05; G01N 21/39

(52) U.S. Cl. CPC G01N 21/3577; G01N 21/05; G01N 21/39

(57) ABSTRACT

A flow meter is positioned in an Microfluidic Modulation Spectroscopy system at the output of the Y junction of a flow cell. The MMS system instantaneously measures the flow rate through the flow cell and adjusts parameters such as fluid backing pressure, valve open time, and dwell time before data collection. This allows an opportunity to optimize the system performance and minimize the fluid usage in real time. The flow sensor is capable of measuring fluid flow in the range of 0-100 microliter per second. The incorporation of the flow meter at the output of the Y junction immediately following measurement of the sample and reference fluids allows for real-time adjustments of operating parameters. The capability of the system to adjust operating parameters and make corrections in real time based on the measurements by the flow meter allows the instrument to automatically measure arrays of samples on a well plate.

### PRIORITY

This patent application claims priority from provisional U.S. patent application No. 63/556,173, filed Feb. 21, 2024, entitled, “INFRARED TRANSMISSION CELL WITH ATTACHED FLOW SENSOR FOR MICROFLUIDIC MODULATION SPECTROSCOPY,” and naming Jinhong Kim, Eugene Ma, and Dennis Merrill as inventors, the disclosure of which is incorporated herein, in its entirety, by reference.

### FIELD

Illustrative embodiments of the invention generally relate to using infra-red transmission spectroscopy and, more particularly, various embodiments of the invention relate to using infra-red transmission spectroscopy to measure biological samples in aqueous solutions.

### BACKGROUND

Microfluidic Modulation Spectroscopy, or MMS, is an ultra-sensitive infrared spectroscopy technique for measuring biological samples in aqueous solutions. This technique has been well established to show as much as 30× improvement in sensitivity and repeatability when measuring proteins in their native formulation. It has shown utility for measuring proteins and nucleic acid (RNA, DNA) structures.

However, in many instances the production of significant amounts of proteins and nucleic acid structures for measurement and characterization is very difficult.

### SUMMARY OF VARIOUS EMBODIMENTS

In accordance with one embodiment of the invention, a system to measure a liquid analyte and a prescribed reference solution in a transmission cell includes a liquid flow cell having a sample chamber with a chamber window configured to alternately receive the liquid analyte and the prescribed reference solution.

The system also includes a tunable optical source configured to emit coherent light across a range of wavelengths. The tunable optical source is configured to transmit the coherent light through the chamber window to produce a chamber signal. The system also includes a detector having an optical range to detect the chamber signal. The detector is configured to detect the chamber signal.

The system also includes a flow sensor configured to measure a flow rate and a flow direction of the liquid analyte and the prescribed reference solution through the output of the liquid flow cell. The flow sensor may measure the flow rate at sampling rate between 10 Hz and 100 kHz.

The flow sensor may be configured to measure flow rate in a forward direction of the fluid flow, in a reverse direction of the fluid flow, or in both a forward direction and reverse direction of the fluid flow.

The measured flow rate may be used to determine a volume of fluid that flows through the liquid flow cell. The measured flow rate may be determined as a function of time to provide diagnostic information about the alternately receiving the liquid analyte and the prescribed reference solution at the liquid flow cell.

The system may further include a controller in electrical communication with the system that may be configured to fully automate the alternatively receiving the liquid analyte and the reference solution. The controller may fully automate the detection of the chamber signal of the liquid analyte spectrum and the reference solution spectrum. The controller may fully automate the measurement of the flow rate of the liquid analyte and the flow rate of the prescribed reference solution.

Furthermore, the controller may be configured to compare the measured flow rate of the liquid analyte to the measured flow rate of the prescribed reference solution to give diagnostic information about the alternately receiving the liquid analyte and the prescribed reference solution at the liquid flow cell.

The diagnostic information may indicate that a flow rate of the liquid analyte or a flow rate of the prescribed reference solution should be increased or decreased. The controller may be configured to automatically determine the measured flow rate as a function of time of the liquid analyte and the prescribed reference solution. The controller may be configured to compare the measured flow rate of the liquid analyte to the measured flow rate of the prescribed reference solution.

The controller may be configured to automatically increase or decrease a gas pressure forcing the one or both of the liquid analyte or the prescribed reference solution from a well plates based on the comparison of the measured flow rate of the liquid analyte to the measured flow rate of the prescribed reference solution.

In accordance with another embodiment of the invention, a method to measure a liquid analyte with a weak absorbance in a prescribed reference solution with a very high absorbance includes alternately flowing the liquid analyte and the prescribed reference solution through a fluid chamber in a liquid flow cell.

The method also includes measuring a flow rate of an output of the liquid flow cell with a flow meter positioned in-line along tubing carrying the output of the liquid flow cell.

The method also includes emitting an infra-red (IR) light from an IR light source. The IR light is filtered through an optical filter.

The method also includes transmitting the filtered IR light through a sample cell in the fluid chamber to produce a chamber signal, and using a detector having an optical range to detect the chamber signal.

A flow rate versus time curve may be determined for the liquid analyte and the prescribed reference solution. The flow rate versus time curves determined for the liquid analyte and the prescribed reference solution may provide diagnostic information about the alternately flowing the liquid analyte and the prescribed reference solution through a fluid chamber in a liquid flow cell. The flow rate versus time curves may be automatically determined for the liquid analyte and the prescribed reference solution. The diagnostic information to control a gas pressure forcing the one or both of the liquid analyte or the prescribed reference solution from the well plates may be automatically provided.

The method may further include reverse-flow priming and flushing the fluid chamber in the liquid flow cell with a system water or a system buffer. The flow meter may determine a flow rate and a flow direction of the system water and the system buffer. The reverse-flow priming and flushing the fluid chamber in the liquid flow cell may effectively remove dead volume in sample delivery paths.

In accordance with another embodiment of the invention, a method to measure a liquid analyte with a weak absorbance in a prescribed reference solution with a very high absorbance includes alternately flowing the liquid analyte and the prescribed reference solution through a fluid chamber in a liquid flow cell to a waste fluid exit line.

The method also includes emitting an infra-red (IR) light from an IR light source. The IR light is filtered through an optical filter.

The method also includes transmitting the filtered IR light through a sample cell in the fluid chamber to produce a chamber signal, and using a detector having an optical range to detect the chamber signal.

The method also includes measuring a flow rate and a flow direction of the waste fluid analyte and prescribed reference solution with a flow meter positioned in the waste fluid exit line.

The method may further include flowing the waste liquid analyte and the waste prescribed reference solution through a 3-way valve positioned between the flow meter and the waste fluid connector.

The method also may further include reverse-flow priming and flushing the fluid chamber in the liquid flow cell through the 3-way valve attached to and in liquid communication with system water and system buffer.

### BRIEF DESCRIPTION OF THE DRAWINGS

Those skilled in the art should more fully appreciate advantages of various embodiments of the invention from the following “Description of Illustrative Embodiments,” discussed with reference to the drawings summarized immediately below.

FIG. 1 shows a conceptual drawing of architecture and components of an infra-red spectroscopic fluid analyzer according to illustrative embodiments.

FIG. 2 shows a schematic layout of an IR spectroscopic fluid analyzer according to illustrative embodiments.

FIG. 3A shows a typical flow pattern for a protein and buffer according to illustrative embodiments.

FIG. 3B shows a plot of differential absorption units (diff-AU) versus wavenumber (cm⁻¹) for a series of the repeated measurements of the differential spectra according to illustrative embodiments.

FIG. 3C shows a plot of a negative of diff-AU versus volume for the series of data points collected for wavenumber 1645 cm⁻¹ according to illustrative embodiments.

FIG. 4 shows an example of an inconsistent flow pattern according to illustrative embodiments.

FIG. 5 shows a schematic diagram of a low-volume MMS system according to illustrative embodiments.

FIG. 6 schematically shows an embodiment of a low-volume MMS system with reverse-flow priming and flushing of the microfluidic controller according to illustrative embodiments.

### DESCRIPTION OF ILLUSTRATIVE EMBODIMENTS

Microfluidic Modulation Spectroscopy, or MMS, is an ultra-sensitive infrared spectroscopy technique for measuring biological samples in aqueous solutions. This technique has been well established to show as much as 30-times improvement in sensitivity and repeatability when measuring proteins in their native formulation. One implementation of the MMS technique includes an MMS system that has a Y junction flow cell positioned within an optical system that uses a tunable coherent laser to measure the fluid present slightly above the junction of the flow path. The “sample” leg of the Y junction gets filled with the analyte (typically protein+buffer) and the “reference” leg of the Y junction gets filled with the pure buffer. Each leg of the Y junction is connected with an inline on-off valve that can turn on or off flow from a pressure backed system. By turning the valves on and off in a pattern, the MMS system therefore flows one fluid at a time in an alternating fashion. Each fluid pushes the previous fluid out of the channel where the laser beam is interrogating the fluid. The fluid may be stopped in the beam for some period of time to allow signal averaging of the data.

In some embodiments, a flow meter (e.g., flow sensor) is positioned in the MMS system at the output of the Y junction. In this way, the MMS system can instantaneously measure the flow rate through the flow cell and adjust parameters such as fluid backing pressure, valve open time, and dwell time before data collection. This allows an opportunity to optimize the system performance and minimize the fluid usage in real time as the measurements are being taken. In some embodiments, the flow sensor is capable of measuring fluid flow in the range of 0-100 microliter per second (e.g., uL/sec). The flow meter may be an impellor flow meter, a turbine, or use a sensor based on measuring optical properties of the flowing fluid.

The incorporation of the flow meter at the output of the Y junction immediately following measurement of the sample and reference fluids allows for real-time adjustments of operating parameters. The capability of the system to adjust operating parameters and make corrections in real time based on the measurements by flow meter allows the instrument to automatically measure arrays of samples on a well plate.

The sample wells on the well plate may be filled with only 50-100 uL, and the sample may be exhausted, leading to complications with continued measurements. Since this method relies on a constant backing pressure at any given time, the actual flow rate is determined by the flow line impedance (e.g., resistance). When the line is only partially filled, which reduces the flow line impedance, the flow rate increases. By using this, the flow meter may be used to detect fluid exhaustion before air reaches the flow cell. This can be done by monitoring the flow rate which will gradually increase as air begins to fill the tip of a sipper tube (e.g., an uptake tube).

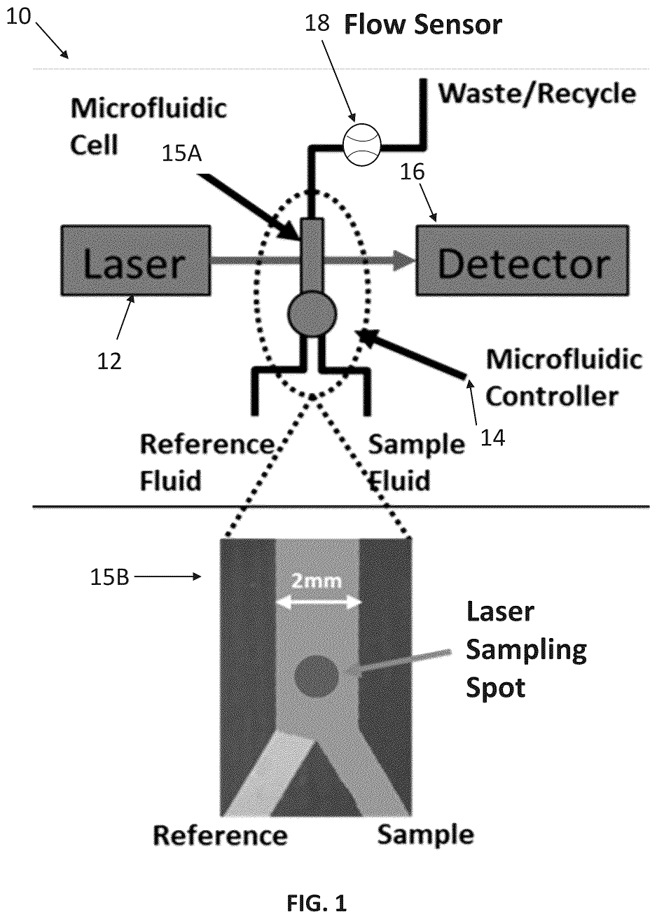

FIG. 1 shows a conceptual drawing of architecture and components of an infra-red (e.g., IR) spectroscopic fluid analyzer 10 (e.g., bioanalyzer) that is configured to measure the IR spectra of a liquid analyte (e.g., sample fluid) and a reference solution (e.g., reference fluid) in which the liquid analyte is dispersed. In this conceptual drawing, the components of the bioanalyzer 10 include a light source 12 (e.g., a coherent laser), a microfluidic controller 14, a detector 16, and a flow sensor 18. The microfluidic controller 14 includes a fluid delivery system via a microfluidic cell 15A (e.g. a liquid flow cell) that has a sample chamber 15B (e.g., sample cell). The microfluidic controller 14 controls the flow of two fluids that are flowed into and out of the sample chamber 15b in an alternating fashion. The microfluidic cell 15A is positioned in a beam path of an IR light that is emitted from the light source 12 and is directed to pass through a window in the sample chamber 15B and proceed to the detector 16.

The microfluidic cell 15A has two inlet channels, one for the sample fluid and one for the reference fluid, and an outlet channel for waste. The height (e.g., the optical pathlength) of the cell channel is on the order of 23 um. Using gas pressure, sample fluids and reference fluids are alternately pushed through the outlet channel. On/off modulation of the flow fluid from each channel is controlled by a microfluidic valve, one for each path (not shown). Furthermore, in embodiments, pushing the fluids through the outlet channels may be accomplished with other types of pumps, such as, syringe pumps, diaphragm pumps, and the like.

In some embodiments, a measurement system may not use a backing pressure to drive flow rate or flow volume. In such systems, a dispense volume (e.g., a volume of fluid dispensed by a valve) or dispense rate (e.g., a rate of fluid dispensed by a valve) may be adjusted at a flow valve instead of being adjusted by backing pressure.

The use of microfluidic techniques have additional advantages. The sample fluids (e.g., liquid analyte) and buffers (e.g., reference fluids) can be changed externally, at will, without hardware changes in the optical path. Furthermore, with the ability to continuously measure samples, the system also allows for use in an on-line application scenario, where process analytical technology and quality control features can be exploited.

Measurement of the sample fluid transparency (e.g., optical absorption spectrum) is conducted when the sample has fully pushed through the optical interrogation region, flushing out all measurable transparency effects of the reference fluid. Multiple measurements are made while the fluids have stopped flowing. Thus, the fluid in the flow cell can have no-flow measurements in MMS system 10.

Likewise, the measurement of the reference fluid transparency is made once it has pushed fully through the optical interrogation region, removing all measurable effects of the transparency of the sample fluid.

The modulation of the on/off flow fluid from each channel can be operated at a rate of between about 0.1 cycles per second and 50 cycles per second without moving the sample cell. There are advantages to modulating the fluids as quickly as possible. For example, rapid switching times can reduce drifts in light signal or detector dark background signal, as well as decrease noise terms that have 1/f characteristics.

The use of a tunable laser with the rapid on/off fluid switching times enables the generation of a high optical power at the measurement wavelengths, which can be used to increase sample cell path length. This combination enables an improved signal to noise ratio on spectral measurements relative to more conventional forms of spectroscopy.

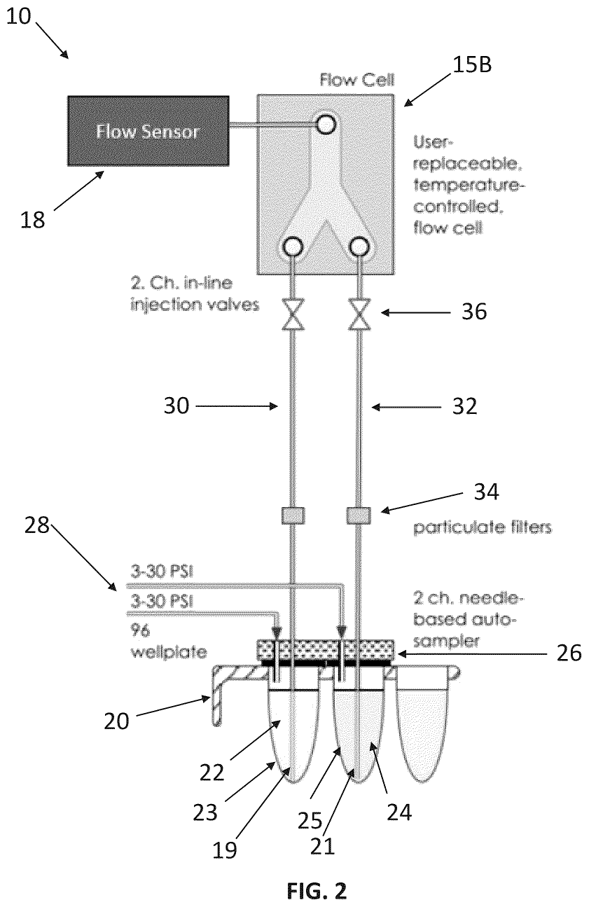

In illustrative embodiments, a flow sensor 18 is included in the MMS system 10 by placing the flow sensor 18 (e.g., flow meter) at the output of the Y junction, as shown in FIG. 2. FIG. 2 shows a schematic view of a portion of an MMS system 10. The MMS system 10 includes a well plate 20 that includes sample wells of reference fluid 22 and sample fluid 24. A two-channel needle-based autosampler 26 is automatically positioned above of the reference fluid well 23 and sample fluid well 25. The autosampler 26 forms air-tight couplings with the reference fluid well 23 and sample fluid well 25. Pressure-controlled gas sources 28 provide a gas at a predetermined pressure to each of the reference fluid well 23 and sample fluid well 25 to push the respective fluids through the reference sipper tube 19 and the reference fluid inlet channel 30, and through the sample sipper 21 and the sample fluid inlet channel 32 into the flow cell 15B. The respective fluids flow through particulate filters 34 and in-line injection valves 36 prior to entering the flow cell 15B. The sample fluid and reference fluid are interrogated as described above, and the fluids exit the flow cell 15B and then through the flow sensor 18.

In this way, the system 10 can effectively instantaneously measure the flow rate through the flow cell 15B and adjust parameters such as fluid backing pressure, valve open time, and dwell time before data collection in order to optimize the system performance and minimize the fluid usage. The flow sensor 18 is be capable of measuring flow in the 0-100 uL/sec range. In some embodiments, the flow sensors have a minimum resolution of at least 0.1 uL/sec. The sensors may be able to measure about 0.2-2 uL per “push” of volume through the flow cell.

The flow sensor 18 can be used to minimize analyte volume usage by adjusting system backing pressure to target the best conditions for fluid exchange. For example, in some embodiments, the infrared flow cell 15B may require about 0.5 uL of volume to adequately flush out the previous sample. In a pressure-controlled flow system where the fluid viscosity is unknown, the flow meter 18 can be used to adjust the fluid backing pressure and the valve 36 open time to produce the correct volume. In some embodiments, the fluid viscosity of the sample 24 or the reference fluid 22, or both, may be between 0.5 and 20 Centipoise (e.g., cP). In some embodiments, the fluid viscosity of the sample 24 or the reference fluid 22 are very different between the sample 24 and the reference 22. For example, high concentration monoclonal antibody (e.g., mAb) solutions may have a viscosity between 3-5 cP and PBS buffer may have a viscosity between 0.9-1 cP. In that instance, for a desired target exchange volume of 0.5 uL and a rate of 1 uL/sec, it may be necessary to provide the sample 24 with 3-5× (e.g., 3 to 5 times) the pressure provided to the reference 22. Additionally flow dynamics such as laminar or turbulent flow can exist as a function of fluid velocity. In some embodiments, the flow cell 15B needs approximately 1 uL/sec flow rate to efficiently clear the previous fluid. A flow rate that is too slow or a volume that is too low will result in some portion of the previous fluid being left in place which can contaminate the results.

The use of the flow sensor 18 in the microfluidic controller 14 in the MMS system can improve volumetric control by integrating the flow rates during valve ON times, and as fluid moves through one leg of the Y junction, the integral of the flow rate can be used to calculate the volume consumption. That is, the fluid volume may be calculated by integrating the flow rates over time. Each cycle of the MMS process can be summed up to measure the total amount of each fluid used. This is important when the MMS system 10 is taking the analytes from a well plate 20 where volume is limited. A well plate 20 may only be filled with 50-100 μL and exhausting the well would push air into the flow cell, causing instability in the data. With the volumetric control allowed by the inline flow sensor 18, the data collection can be optimized to produce the maximum amount of data without exhausting the available fluid volume.

The use of the flow sensor 18 in the MMS system 10 can improve the monitoring of fluid stability during data collection by reducing fluid consumption during MMS cycles. The flow sensor 18 may stop the analyte in the flow cell 15B for short periods of 0.5-10 seconds before exchanging with the alternate fluid. After the valve 36 is closed, the flow sensor 18 can be used to monitor that the fluid has stopped moving before collecting data. This provides a more stable measurement that avoids changes due inconsistent fluid movement.

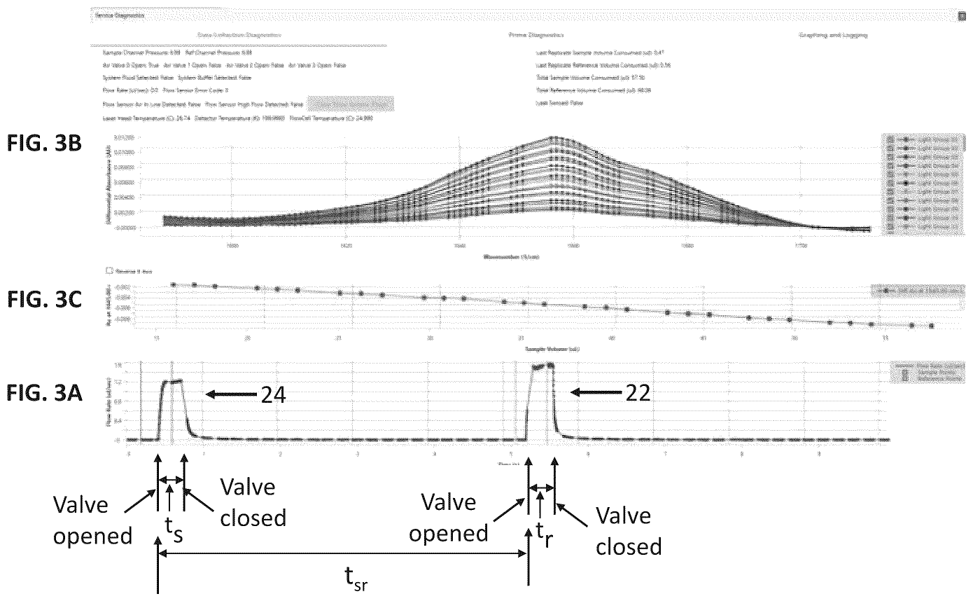

The use of the flow sensor 18 in the MMS system 10 can be used to monitor fluid flow patterns, because the flow patterns can give diagnostic information about the state of the fluidic system. FIG. 3A shows a typical flow pattern for a cycle of measuring a sample fluid 24 (a protein) and reference fluid 22 (a buffer). The trace in FIG. 3A is a plot of fluid flow rate (x-axis) versus time (y-axis), with the major time markings being in seconds.

The trace in FIG. 3A shows that the flow of sample fluid 24 flows for a time, tₛ, which, in this non-limiting example, is about 400 milliseconds (ms). The flow of the sample fluid 24 out of the sample well starts when the valve is opened and proceeds until the valve is closed. The flow sensor 18 detects when the flow starts and when it ends, resulting in measured time, tₛ. The total amount of sample fluid 24 that passes through the flow cell 15B corresponds to the area under the curve for time, tₛ.

The same is true for the reference fluid 22. The flow of the reference fluid 22 out of the reference well 23 starts when the valve is opened and proceeds until the valve is closed. The reference fluid 22 flows for a time, tᵣ, which, in this non-limiting example, is about 400 milliseconds (ms). The flow sensor 18 detects when the flow starts and when it ends, resulting in measured time, tᵣ. The total amount of reference fluid 22 that passes through the flow cell 15B corresponds to the area under the curve for time, tᵣ.

The differences in flow rate for the sample fluid 24 and the reference fluid 22 in FIG. 3A can be due to one or more of several factors. For example, the difference in flow rate could be due to a difference in viscosity between the two fluids. The difference could also be due to variations in the inner diameter of the tubing through which the fluids flow. Furthermore, the differences in flow rate could be due to dimensional variations other parts of the flow path, such as dimensional tolerance of the flow cell and valves. These differences could be well within the tolerances of the inner diameter of the tubing. The flow rate difference could also be due to slight differences in fluid resistance between the sample fluid 24 and the reference fluid 22 and the polymer tubing of the reference fluid inlet channel 30 and the sample fluid inlet channel 32.

The difference in time between the start of the sample fluid 24 flow and the start of the reference fluid 22 flow is time tₛᵣ and is adjusted to optimize the sample rate. The time tₛᵣ between opening the valve for the sample fluid 24 and opening the valve for the reference fluid 22 flow 5 seconds. The sample rate can be adjusted to maximize a resolution between the sample fluid 24 and the reference fluid 22, to maximize a sample fluid signal strength.

FIG. 3B shows a plot of Differential Absorption Units (DAU) versus Wavenumber (1/cm) for a series of the repeated measurements of the differential spectra between a spectrum of the sample fluid 24 and a spectrum of the reference fluid 22. The increasing signal strength is indicative of the increasing concentration of the sample fluid 24 relative to the reference fluid 22. The peak in the differential spectra was at about 1650 cm⁻¹.

FIG. 3C shows a plot of a negative of DAU versus volume for the series of data points collected for wavenumber 1645 cm⁻¹. The decrease of the negative of the DAU indicates that the intensity of the differential absorption at 1650 cm⁻¹ was increasing until it flattened out at about 55 μL of sample fluid 24.

The shape of the flow rate versus time trace can serve as a diagnostic of the sample flow through the MMS system 10. Referring again to FIG. 3A, opening the valve causes the flow rate to increase from zero to a preset constant flow rate which continues until the valve is closed. After closing the valve, the flow rate quickly begins to drop and decay until the flow rate returns to a zero. This flow rate behavior is illustrated for both the sample fluid 24 and the reference fluid 22 in FIG. 3A.

The type of nearly square wave behavior for both the sample fluid 24 and the reference fluid 22 in FIG. 3A indicates that the microfluidic controller 14 is properly starting and stopping the fluid flow.

The shape of the flow rate versus time trace can also indicate if there problems with fluid flow through the MMS measurement system 10. For example, if there is a “tail” after the valve is closed, it may indicate a problem such as an air bubble in the fluid tubing or a damaged flow cell. For example, a “tail” may indicate a leak in one or more of the MMS valves. If the flow rate does not drop to zero, it may mean that the valves are leaking. The valves tend to have a finite lifetime due to frictional wear of the rotary mechanism, so this information can be used to indicate service is required.

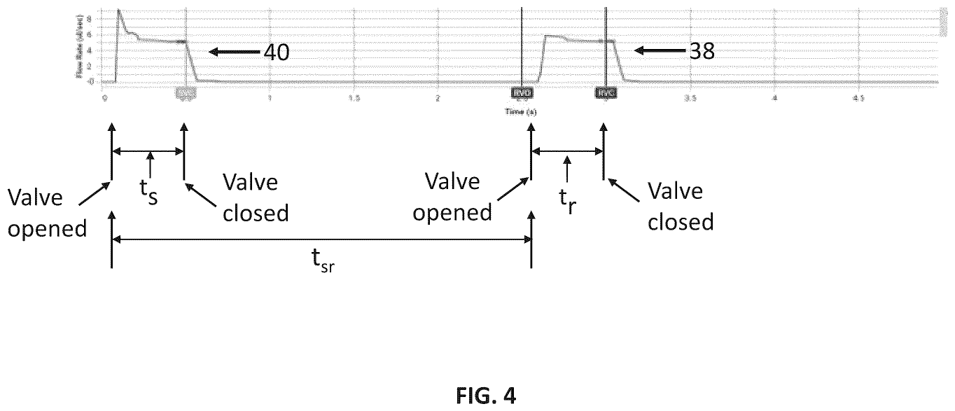

FIG. 4 shows an a trace of flow rate versus time for sample fluid 40 and a reference fluid 38. FIG. 4 illustrates an example of an inconsistent flow pattern. The flow rate starts increasing when the valve for the sample fluid 40 is opened. But the flow rate reaches a maximum of 9 uL/sec before dropping off nearly 45% to a steady state of about 5 uL/sec. After being open for about 400 milliseconds, the valve is closed and the flow rate starts dropping. However, the rate of drop off is not as fast as ideal. That is, the slope of the curve of flow rate versus time is not as steep as desired for optimal operation.

The average sample flow rate for sample 40 is about 5.093 uL/sec, which consumed about 2.57 uL.

FIG. 4 also includes the flow rate versus time trace for the reference fluid 38. The flow rate starts increasing when the valve for the reference fluid 38 is opened. The flow rate reaches a maximum of about 6 uL/sec before dropping off to a steady state of about 5 uL/sec. After being open for about 400 milliseconds, the valve is closed and the flow rate starts dropping. However, the rate of drop off is not as fast as ideal, similar as for the sample fluid 40. The average flow rate for reference 38 is about 5.143 uL/sec, which consumed about 2.48 uL.

The unexpected and non-ideal flow rate versus time traces illustrated by the sample 40 and reference 38 may be an indication of having an air bubble in the microfluidic controller 14 at some point. An air bubble can affect the flow rate by expanding and contracting. Air bubbles can work as soft springs between rigid components (incompressible test fluid) that overshoot whenever either valve opens or closes. The presence of air bubbles in the fluid lines is typically identified as large spikes up or down in the flow rate versus time curves. An unexpected and non-ideal flow rate versus time trace may also indicate viscosity differences between fluids, and indicate temperature variations.

Furthermore, non-ideal flow rate versus time traces can indicate whether the system is adequately primed or flushed. Put another way, the detection of the presence of air bubbles in the fluid path because of an inconsistent flow pattern can be indicative on an inadequately primed or flushed system.

The flow sensor 18 may also be used to provide flow rate stability under temperature ramping. Users of MMS systems often desire to change the temperature of the analytes as they are being analyzed in order to induce structural changes in the biomolecules. Changing the temperature of the solution can also change the dynamic viscosity and thus change the flow rate and a pressure-backed system. The flow sensor in this embodiment can monitor these changes and adjust the pressure dynamically.

The flow sensor 18 may also be used to determine pressure dependence on viscosity and provide an opportunity to control flow rate with gas pressure and measure with flow sensor 18. Since the flow sensor 18 measures the instantaneous flow rate, it is possible to vary the gas pressure behind the sample flow in real time to discover what gas pressures are required to dial the flow rate to an optimal value.

The flow sensor 18 may also be used to measure fluid flow direction. It is critical to be able to determine the direction of fluid flow, because, in some cases it is advantageous to flow fluid in the reverse direction to clean the cell between samples or prime the system with water. The flow sensor can check the directionality and stability of the flow in order to perform the operations successfully. Additionally, it can monitor for backflow (flowing backwards through a valve which should be closed) which would indicate a failure of the shutoff valve. Shutoff valves can wear over time so this can be useful for diagnostic purposes. In some instances, if the flow rate does not drop to zero, it is indicative of a valve that is leaking.

The flow sensor 18 may also be used to monitor unusually low or high flow rates. Low or no flow when the valve is open could indicate a blockage due to particulate or aggregation. This is particularly common in a thin pathlength flow cell such as used in MMS. The flow sensor in this configuration can detect blockage and trigger a cleaning operation to deal with it automatically. Likewise, a too high flow rate can indicate the presence of an air bubble in the system

The presence of the flow sensor 18 can correct for the build up of extra fluid volume in one or more of the front-end components, including the system components from the needle tip to the flow cell. The build up of system water and/or system buffer can result in increased carryover of diluting fluids into the measurement process, which in turn may require a significantly increased sample volume for setup and testing. By adding the flow sensor 18 to waste port of the MMS system 10, accurate fluid dispensing and monitoring are increased because the flow sensor 18 does not cause carryover due to its placement at the waste port, as shown in FIG. 2.

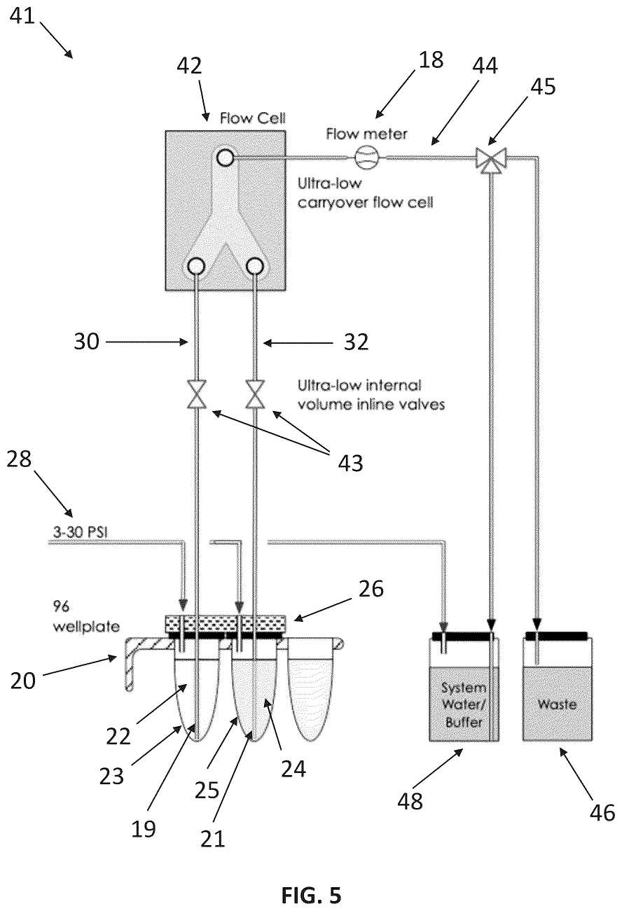

In some embodiments, the MMS system 41 is configured to handle very low volumes of sample fluid and reference fluid. FIG. 5 shows a schematic diagram of a low-volume MMS system 41 that includes an ultra-low carryover flow cell 42 and ultra-low internal volume inline valves 43. The low-volume MMS system 41 also includes a flow meter 18 positioned in an exit line 44 of the flow cell 42. The flow meter 18 is mounted in an exit line 44 before a valve 45 that can direct the waste fluid in the exit line 44 to a waste fluid collector 46 or a system water and buffer collector 48.

The MMS system 41 includes a well plate 20 that includes sample wells of reference fluid 22 and sample fluid 24. A two-channel needle-based autosampler 26 is automatically positioned above of the reference fluid well 23 and sample fluid well 25. The autosampler 26 forms air-tight couplings with the reference fluid well 23 and sample fluid well 25. Pressure-controlled gas sources 28 provide a gas at a predetermined pressure to each of the reference fluid well 23 and sample fluid well 25 to push the respective fluids through the reference fluid inlet channel 30 and the sample fluid inlet channel 32 through the ultra-low internal volume inline valves into the ultra-low carryover flow cell 42. The sample fluid 24 and reference fluid 22 are interrogated as described above, and the fluids exit the ultra-low carryover flow cell 42 through the flow meter 18 and the a valve 45 that directs the waste fluid in the exit line 44 to a waste fluid collector 46 or a system water and buffer collector 48.

In this way, the system 41 can instantaneously measure the flow rate through the flow cell 41 and adjust parameters such as fluid backing pressure, valve open time, and dwell time before data collection in order to optimize the system performance and minimize the fluid usage. The flow sensor 18 is be capable of measuring flow in the 0-100 uL/sec range.

In some embodiments, an MMS system includes reverse-flow priming and flushing of the microfluidic controller from system bottles, in addition to a reversable flow meter. The reverse-flow priming and flushing can be done automatically or can be controlled by a user.

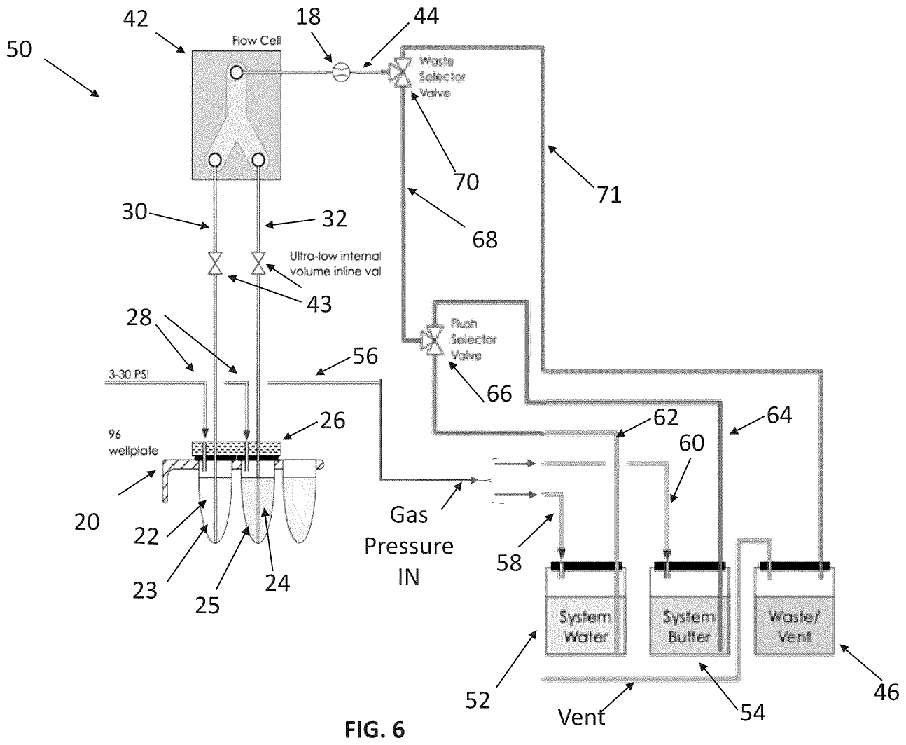

FIG. 6 shows a schematic illustration of a MMS system 50 configured to provide reverse-flow priming and flushing of the microfluidic controller 14. The MMS system 50 includes an ultra-low carryover flow cell 42 and ultra-low internal volume inline valves 43. The MMS system 50 also includes a flow meter 18 positioned in an exit line 44 of the flow cell 42.

The MMS system 50 includes a well plate 20 that includes sample wells of reference fluid 22 and sample fluid 24. A two-channel needle-based autosampler 26 is automatically positioned above of the reference fluid well 23 and sample fluid well 25. The autosampler 26 forms air-tight couplings with the reference fluid well 23 and sample fluid well 25. Pressure-controlled gas sources 28 provide a gas at a predetermined pressure to each of the reference fluid well 23 and sample fluid well 25 to push the respective fluids through the reference fluid inlet channel 30 and the sample fluid inlet channel 32 through the ultra-low internal volume inline valves into the ultra-low carryover flow cell 42. The sample fluid 24 and reference fluid 22 are interrogated as described above, and the fluids exit the ultra-low carryover flow cell 42 through the flow meter 18 in the exit line 44.

Reverse-flow priming and flushing is accomplished by pushing either system water 52 or system buffer 54 back up through the flow sensor 18 into the flow cell 42. Gas pressure provided through lines 56 is provided to the system water 52 source by line 58 or to the system buffer source 54 through line 60. Either the system water 52 or system buffer 54 is pushed by gas pressure through lines 62 or 64, respectively, to a flush selector valve 66, and then up through flush line 68 to waste selector valve 70. Flush selector valve 66 allows selection of either the system water 52 flowing through line 62, or the system buffer 54 flowing through line 64, or neither. That is, flush selector valve 66 can allow system water 52, system buffer 54, or nothing to flow through flush line 68.

Waste selector valve 70 is positioned after the flow sensor 18 on exit line and 44 provides selection between allowing waste fluid exit the flow cell 42 and travel through line 71 to the waste collector 46, or allowing system water 52 or system buffer 54 to proceed through the flow meter 18 into the flow cell 42.

The MMS systems can be operated at high throughput even though the available sample size may be small. That is, even though the available sample volume may be less 200 uL (e.g., <200 uL)), the MMS systems can still operate by drawing the small sample from a plate.

By enabling reverse-flow priming and flushing of the microfluidic controller 14, MMS system 50 effectively removes dead volume in the sample delivery paths and using a no-flow measurements of the spectra, various embodiments can achieve an order of magnitude reduced sample volume. That is, the sample volume required to take the IR measurements can be reduced by an order of magnitude and still retain the same quality of measurements as before the introduction of the flow sensor 18 and reverse-flow priming and flushing of the microfluidic controller 14. Accurate fluid dispensing and monitoring are enabled by the added flow sensor that does not cause carryover due to its placement at the waste port.

In some embodiments, it is possible to determine if the system has not been sufficiently primed or flushed by the presence of an inconsistent flow pattern in the flow rate versus time curves (e.g., traces). In this case, the inconsistent flow pattern in the flow rate versus time curves is indicating that there are air bubbles in the fluid path that need to be removed.

It is surprising that by adding a flow meter to a line following a sample measurement flow cell can lead to an increase in the measurement capacity of an MMS system. That is, by installing a flow sensor (e.g., meter) on the output of a measurement microfluidic cell rather than on sample and reference input lines enables an order of magnitude smaller sample size without losing measurement quality. The surprising improvement is in part due to being able to accurately determine flow rates of low volumes (<200 uL) of sample and reference fluids. By locating the flow meter after the flow cell, it is possible to monitor flow rate and volume of the sample and reference fluids in real time, and use the real time measurements to adjust gas pressure forcing the fluids from the well plates.

Furthermore, by placing the flow meter after the flow cell, it is possible to reduce the volume of the fluids necessary to prepare and flush the microfluidic system before the flow cell.

Thus, by providing a flow meter following the flow cell, it is possible to provide real time feedback control of the MMS technique which requires monitoring the dynamic automated system utilizing well plates with small sample sizes (<200 uL) and switching fluids. The MMS techniques require more real-time control than static IR measurement methods which involve manually replacing samples with relatively larger volumes (>milliliters) and longer measurement times (>minutes).

Furthermore, by providing a flow meter following the flow cell, it is possible to determine whether the system is adequately primed or flushed. An inconsistent flow pattern can be indicative of air bubbles in the fluid path which may be the result of an inadequately primed or flushed system.

The embodiments of the invention described above are intended to be merely exemplary; numerous variations and modifications will be apparent to those skilled in the art.

What is claimed is:

1. A system to measure a liquid analyte and a prescribed reference solution in a transmission cell, the system comprising:
a liquid flow cell having a sample chamber with a chamber window configured to alternately receive the liquid analyte and the prescribed reference solution;
a tunable optical source configured to emit coherent light across a range of wavelengths, the tunable optical source configured to transmit the coherent light through the chamber window to produce a chamber signal;
a detector having an optical range to detect the chamber signal, the detector configured to detect the chamber signal;
a flow sensor configured to measure a flow rate and a flow direction of the liquid analyte and the prescribed reference solution through the output of the liquid flow cell.

2. The system of claim 1, wherein the flow sensor measures the flow rate a sampling rate between 10 Hz and 100 kHz.

3. The system of claim 1, wherein the flow sensor is configured to measure flow rate:
in a forward direction of the fluid flow;
in a reverse direction of the fluid flow; or
in both a forward direction and reverse direction of the fluid flow.

4. The system of claim 1, wherein the measured flow rate is used to determine a volume of fluid that flows through the liquid flow cell.

5. The system of claim 1, wherein the measured flow rate is determined as a function of time to provide diagnostic information about the alternately receiving the liquid analyte and the prescribed reference solution at the liquid flow cell.

6. The system of claim 1 further comprising:
a controller in electrical communication with the system configured to:
fully automate the alternatively receiving the liquid analyte and the reference solution;
fully automate the detection of the chamber signal of the liquid analyte spectrum and the reference solution spectrum; and
fully automate the measurement of the flow rate of the liquid analyte and the flow rate of the prescribed reference solution.

7. The system of claim 6, wherein the controller is configured to compare measured flow rate of the liquid analyte to the measured flow rate of the prescribed reference solution to give diagnostic information about the alternately receiving the liquid analyte and the prescribed reference solution at the liquid flow cell.

8. The system of claim 7, wherein the diagnostic information indicates that a flow rate of the liquid analyte or a flow rate of the prescribed reference solution should be increased or decreased.

9. The system of claim 8, wherein the controller is configured to automatically:
determine the measured flow rate as a function of time of the liquid analyte and the prescribed reference solution; and
compare the measured flow rate of the liquid analyte to the measured flow rate of the prescribed reference solution.

10. The system of claim 9, wherein the controller is configured to automatically increase or decrease a gas pressure forcing the one or both of the liquid analyte or the prescribed reference solution from a well plates based on the comparison of the measured flow rate of the liquid analyte to the measured flow rate of the prescribed reference solution.

11. A method to measure a liquid analyte with a weak absorbance in a prescribed reference solution with a very high absorbance, comprising:
alternately flowing the liquid analyte and the prescribed reference solution through a fluid chamber in a liquid flow cell;
measuring a flow rate of an output of the liquid flow cell with a flow meter positioned in-line along tubing carrying the output of the liquid flow cell;
emitting an infra-red (IR) light from an IR light source, the IR light being filtered through an optical filter;
transmitting the filtered IR light through a sample cell in the fluid chamber to produce a chamber signal; and
using a detector having an optical range to detect the chamber signal.

12. The method of claim 11, wherein a flow rate versus time curve is determined for the liquid analyte and the prescribed reference solution.

13. The method of claim 12, wherein the flow rate versus time curves determined for the liquid analyte and the prescribed reference solution provides diagnostic information about the alternately flowing the liquid analyte and the prescribed reference solution through a fluid chamber in a liquid flow cell.

14. The method of claim 13, wherein:
the flow rate versus time curves are automatically determined for the liquid analyte and the prescribed reference solution; and
the diagnostic information to control a gas pressure forcing the one or both of the liquid analyte or the prescribed reference solution from the well plates is automatically provided.

15. The method of claim 11 further comprising:
reverse-flow priming and flushing the fluid chamber in the liquid flow cell with a system water or a system buffer.

16. The method of claim 15, wherein the flow meter determines a flow rate and a flow direction of the system water and the system buffer.

17. The method of claim 15, wherein the reverse-flow priming and flushing the fluid chamber in the liquid flow cell effectively removes dead volume in sample delivery paths.

18. A method to measure a liquid analyte with a weak absorbance in a prescribed reference solution with a very high absorbance, the method comprising:
alternately flowing the liquid analyte and the prescribed reference solution through a fluid chamber in a liquid flow cell to a waste fluid exit line;
emitting an infra-red (IR) light from an IR light source, the IR light being filtered through an optical filter;
transmitting the filtered IR light through a sample cell in the fluid chamber to produce a chamber signal;
using a detector having an optical range to detect the chamber signal; and
measuring a flow rate and a flow direction of the waste fluid analyte and prescribed reference solution with a flow meter positioned in the waste fluid exit line.

19. The method of claim 18, further comprising:
flowing the waste liquid analyte and the waste prescribed reference solution through a 3-way valve positioned between the flow meter and the waste fluid connector.

20. The method of claim 18, further comprising:
reverse-flow priming and flushing the fluid chamber in the liquid flow cell through the 3-way valve attached to and in liquid communication with system water and system buffer.
